(19) United States
(12) Patent Application Publication
(10) Pub. No.: US 2013/0214721 A1
(43) Pub. Date: Aug. 22, 2013

(54) PORTABLE ELECTRONIC DEVICE COMPRISING SOLAR POWERED FUNCTION

(71) Applicants: HONG FU JIN PRECISION INDUSTRY (ShenZhen) CO. LTD, (US); HON HAI PRECISION INDUSTRY CO., LTD., (US)

(72) Inventor: HAI-QING ZHOU, Shenzhen (CN)

(73) Assignees: HON HAI PRECISION INDUSTRY CO., LTD., New Taipei (TW); HONG FU JIN PRECISION INDUSTRY (ShenZhen) CO. LTD, Shenzhen (CN)

(21) Appl. No.: 13/720,902

(22) Filed: Dec. 19, 2012

(30) Foreign Application Priority Data
Feb. 17, 2012 (CN) 201210035899.1

(51) Int. Cl. H02J 7/00

(52) U.S. Cl. CPC H02J 7/00
USPC 320/101

(57) ABSTRACT

A portable electronic device includes a battery, a normal charge module, a solar powered module, and a switch. The normal charge module charges the battery from a commercial power source. The solar powered module includes a solar panel and a voltage converting circuit, the solar panel converts light into electricity outputs a voltage of the electricity to the voltage converting circuit, the voltage converting circuit converts the voltage output from the solar panel into a charging voltage, and rectifies and filters the charging voltage which is then output to the battery, to charge the battery. The switch selectively connects the battery either to the normal charge module or to the solar powered module.

### BACKGROUND

1. Technical Field

The exemplary disclosure generally relates to portable electronic devices, and particularly to a portable electronic device having solar powered function.

2. Description of Related Art

Portable electronic devices, such as mobile phones or tablet computers, for example, use battery to obtain power. The battery is charged by alternating current (AC) power via a charger. However, when a user is in remote areas having no AC power and the power of the battery is depleted, the portable electronic device will run out of power, which is very inconvenient.

Therefore, there is room for improvement within the art.

### BRIEF DESCRIPTION OF THE DRAWINGS

Many aspects of the embodiments can be better understood with reference to the drawings. The components in the drawings are not necessarily drawn to scale, the emphasis instead being placed upon clearly illustrating the principles of the disclosure.

FIG. 1 shows a block diagram of an exemplary embodiment of a portable electronic device having a solar powered function.

FIG. 2 shows a circuit diagram of the portable electronic device shown in FIG. 1.

### DETAILED DESCRIPTION

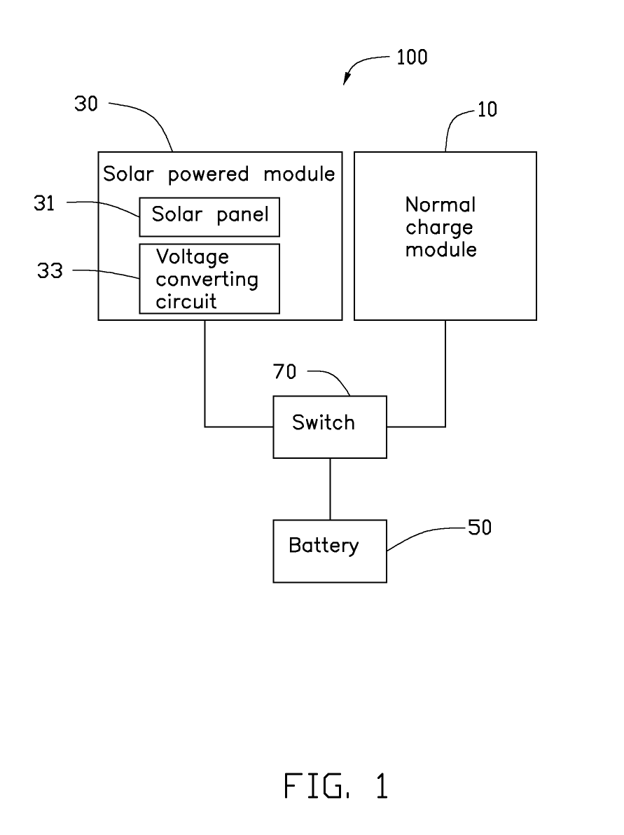

FIG. 1 shows a block diagram of a portable electronic device 100 having a solar powered function. The device 100 includes a normal charge module 10, a solar powered module 30, a battery 50, and a switch 70. The normal charge module 10 charges the battery 50 from a commercial power source, such as an AC outlet. The solar powered module 30 receives light, and converts the light into electricity to charge the battery 50. The switch 70 is electronically connected to the normal charge module 10, the solar powered module 30, and the battery 50. The switch 70 selectively connects the battery 50 either to the normal charge module 10 or to the solar powered module 30, thereby switching a charge mode of the battery 50. For example, the switch 70 connects the battery 50 to the solar powered module 30 when the solar powered module 30 can obtain light, and connects the battery 50 to the normal charge module 10 when the solar powered module 30 cannot obtain light.

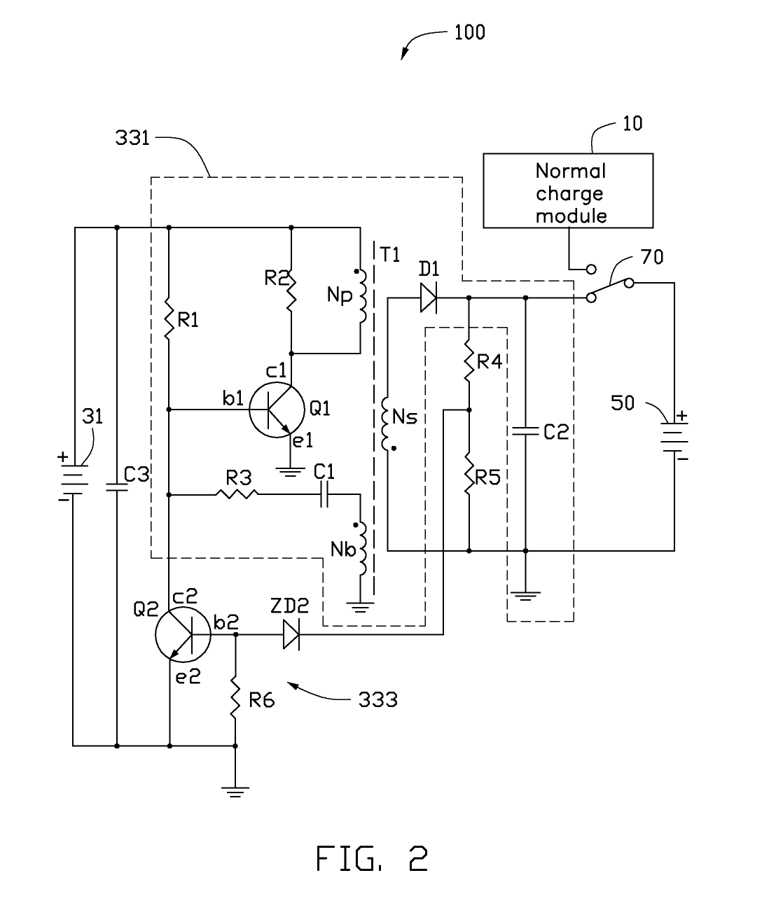

FIG. 2 shows a circuit diagram of the device 100 shown in FIG. 1. The solar powered module 30 includes a solar panel 31 and a voltage converting circuit 33. The solar panel 31 converts light received into electricity, and outputs the electricity to the voltage converting circuit 33. In the exemplary embodiment, the solar powered module 30 includes one solar panel 31. In other embodiments, the solar powered module 30 can include at least two solar panels connected in series. The solar panel 31 can be positioned on a back cover (not shown) of the device 100.

The voltage converting circuit 33 includes a charge unit 331 and a voltage limiting unit 33. The charge unit 331 converts a voltage output from the solar panel 31 into a charging voltage and rectifies and filters the charging voltage, which is output to the battery 50. The voltage limiting unit 333 limits the charging voltage to a predetermined maximum voltage, to prevent overcharging of the battery 50.

The charge unit 331 includes a transformer T1, a first bipolar junction transistor (BJT) Q1, a base resistor R1, a collector resistor R2, a feedback resistor R3, a feedback capacitor C1, a rectifying diode D1, and a first filtering capacitor C2. The transformer T1 includes a primary winding Np, a feedback winding Nb coupled with the primary winding Np, and a secondary winding Ns coupled with the primary winding Np and the feedback winding Nb. A base b1 and a collector c1 of the first BJT Q1 are electronically connected to a positive pole of the solar panel 31 via the base resistor R1 and the collector resistor R2 respectively, and an emitter el of the BJT Q1 is grounded.

A dotted end (terminal) of the primary winding Np (see FIG. 2) is electronically connected to the positive pole of the solar panel 31, and an undotted terminal is electronically connected to a node between the collector resistor R2 and the collector cl of the first BJT Q1. A dotted terminal of the feedback winding Nb is electronically connected to a node between the base resistor R1 and the base b1 of the first BJT Q1 via the feedback capacitor C1 and the feedback resistor R3, and a undotted terminal of the feedback winding Nb is grounded. A dotted terminal of the secondary winding Ns is grounded, and a undotted terminal of the secondary winding Ns is electronically connected to an anode of the rectifying diode D1. A cathode of the rectifying diode D1 is electronically connected to a positive pole of the battery 50. The filtering capacitor C2 is electronically connected in parallel with the battery 50.

The transformer T1, the first BJT Q1, the base resistor R1, the collector resistor R2, the feedback resistor R3, and the feedback capacitor C1 cooperatively form a self-exciting oscillation circuit, such that the primary winding Np generates a varying self-induction voltage and a varying self-induction current, and the secondary winding

Ns generates a varying mutual induction voltage and varying mutual induction current. The varying mutual induction voltage and the varying mutual induction current are then rectified by the rectifying diode D1, and filtered by the filtering capacitor C1, to be converted into a direct current (DC) voltage and current to charge the battery 50.

In detail, the output of current from the positive pole of the solar panel 31 flows to the base b1 of the first BJT Q1 to switch on the first BJT Q1. At this time, the first BJT Q1 is in a forward-active mode. The primary winding Np receives the DC current from the positive pole of the solar panel 31 and generates the self-induction voltage which is positive at the dotted terminal of the primary winding Np, and the current flowing through the primary winding Np increases with the increase of the current at the collector cl. Since the current flowing through the primary winding Np has changed (by being increased), the feedback winding Nb generates a mutual induction current and a mutual induction voltage, which is positive at the dotted terminal of the feedback winding Nb. The mutual induction current generated by the feedback winding Nb, which is output from the dotted terminal of the feedback winding Nb to the base b1 of the first BJT Q1 via the feedback capacitor C1 and the feedback resistor R3, further increases the current at the base b1, causing the current of the collector c1 of the first BJT Q1 to increase further until the first BJT Q1 goes into a saturation mode. Meanwhile, the mutual induction current generated by the feedback winding Nb charges the feedback capacitor C1. An electric potential of the feedback capacitor C1 increases gradually, causing an electric potential of the base b1 to decrease gradually. When the current of the base b1 of the first BJT Q1 cannot maintain the first BJT Q1 in saturation mode, the first BJT Q1 returns to the forward-active mode.

When the first BJT Q1 is in saturation mode, the current at the collector c1 is maintained at a maximum current. When the first BJT Q1 returns to the forward-active mode, the current at the collector c1 decreases from the maximum current. At this time, the self-induction voltage generated by the primary winding Np is reversed, the secondary winding Ns generates a mutual induction current and a mutual induction voltage which is positive at the undotted terminal of the secondary winding Ns. The mutual induction current generated by the secondary winding Ns charges the battery 50 via the rectifying diode D1 and the filtering capacitor C2. Meanwhile, the mutual induction voltage generated by the feedback winding Nb reverses, decreasing the current at the base b1, and the current of the collector c1 decreases correspondingly until the first BJT Q1 goes into a cut-off mode (is switched off).

After the first BJT Q1 goes into cut-off mode, the feedback capacitor C1 is charged in reverse by the voltage output from the solar panel 31 and the reversed mutual induction voltage of the feedback winding Nb, the electrical potential of the base b1 of the first BJT Q1 is thus increased to switch on the first BJT Q1 again, and the charge unit 331 repeats the aforementioned process to continuously charge the battery 50.

The voltage limiting unit 333 includes a second BJT Q2, a zener diode ZD2, a first voltage dividing resistor R4, a second voltage dividing resistor R5, and a current dividing resistor R6. The first and second voltage dividing resistors R4 and R5 are connected in series, and are connected in parallel with the first filtering capacitor C2. A cathode of the zener diode ZD2 is electronically connected to a node between the first and second voltage dividing resistors R4 and R5, and an anode of the zener diode ZD2 is electronically connected to a base b2 of the second BJT Q2. A collector c2 of the second BJT Q2 is electronically connected to a node between the feedback resistor R3 and the base b1 of the first BJT Q1, and an emitter e2 of the second BJT Q2 is grounded. The current dividing resistor R6 is electronically connected to the base b2 and the emitter e2 of the second BJT Q2.

When the battery 50 is being charged by the charge unit 331, the voltage of the battery 50 increases gradually. When the voltage of the battery 50 exceeds a certain charged voltage (e.g. 4.2V), the first and second voltage dividing resistors R4 and R5 output a voltage divided from the voltage of the battery 50, to switch on the zener diode ZD2 and the second BJT Q2. The second BJT Q2 divides the current of the base b1 of the first BJT Q1, thereby decreasing the current at the base b1 and the current at the collector c1 of the first BJT Q1. At this time, the mutual induction voltage and the mutual induction current of the secondary winding Ns decrease correspondingly to maintain the voltage of the battery at the certain charged voltage.

In the exemplary embodiment, the voltage converting circuit 33 further includes a second filtering capacitor C3 connected to the solar panel 31 in parallel.

The switch 70 selectively connects the battery 50 to only one of the normal charge module 10 and the solar powered module 30, such that the device 30 enables a choice of either the normal charge module 10 or the solar powered module 30, to charge the battery 50 according to the situation. For example, a user can choose commercial power source to charge the buttery 50 via an AC power charger (not shown) at night, and choose the solar powered module 30 to charge the battery 50 in daytime, which not only saves electrical power but also is very convenient.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A portable electronic device, comprising:
a battery;
a normal charge module charging the battery from a commercial power source;
a solar powered module comprising a solar panel and a voltage converting circuit, the solar panel converting light into electricity and outputting a voltage of the electricity to the voltage converting circuit; the voltage converting circuit converting the voltage output from the solar panel into a charging voltage, and rectifying and filtering the charging voltage that is output to the battery, to charge the battery; and
a switch selectively connecting the battery to one of the normal charge module and the solar powered module, wherein the switch electronically connects the battery to the solar powered module when the solar panel can obtain light, and electronically connects the battery to the normal charge module when the solar panel cannot obtain light.

2. The portable electronic device of claim 1, wherein the voltage converting circuit comprises a charge unit converting the voltage output from the solar panel to the charging voltage, the charge unit comprises a transformer, the transformer comprises a primary winding electronically connected to the solar panel, and a secondary winding coupled to the primary winding and electronically connected to the battery.

3. The portable electronic device of claim 2, wherein the charge unit further comprises a first bipolar junction transistor (BJT), a base resistor, a collector resistor, a feedback resistor, and a feedback capacitor, the transformer further comprises a feedback winding coupled with the primary winding and the secondary winding, a base and a collector of the first BJT are connected to a positive pole of the solar panel via the base resistor and the collector resistor respectively, and an emitter of the first BJT is grounded; a dotted terminal of the primary winding is electronically connected to the positive pole of the solar panel, and an undotted terminal of the primary winding is electronically connected to a node between the collector resistor and the collector of the first BJT; the dotted terminal of the feedback winding is electronically connected to a node between the base resistor and the base of the first BJT via the feedback capacitor and the feedback resistor, and an undotted terminal of the feedback winding is grounded; the dotted terminal of the secondary winding is grounded, and an undotted terminal of the secondary winding is electronically connected to the a positive pole of the battery.

4. The portable electronic device of claim 3, wherein the voltage converting circuit further includes a rectifying diode and a filtering capacitor, an anode cathode of the rectifying diode is electronically connected to the undotted terminal of the secondary winding, a cathode of the diode is electronically connected to the positive pole of the battery, the filtering capacitor is electronically connected in parallel with the battery.

5. The portable electronic device of claim 4, wherein the voltage converting circuit further comprises a voltage limiting unit that limits the charging voltage output from the charge unit to a predetermined maximum voltage.

6. The portable electronic device of claim 5, wherein the voltage limiting unit comprises a second BJT, a zener diode, a first voltage dividing resistor, a second voltage dividing resistor, and a current dividing resistor, the first and second voltage dividing resistors are connected in series, and are then connected in parallel with the first filtering capacitor;
a cathode of the zener diode is electronically connected to a node between the first and second voltage dividing resistors, and an anode of the zener diode is electronically connected to a base of the second BJT, a collector of the second BJT is electronically connected to a node between the feedback resistor and the base of the first BJT, and an emitter of the second BJT is grounded, the current dividing resistor is electronically connected to the base and the emitter of the second BJT.

7. A portable electronic device, comprising:
a battery;
a normal charge module charging the battery from a commercial power source;
a solar powered module comprising a solar panel and a voltage converting circuit, the solar panel converting light into electricity and outputting a voltage of the electricity to the voltage converting circuit; the voltage converting circuit converting the voltage output from the solar panel into a charging voltage, and rectifying and filtering the charging voltage that is output to the battery, to charge the battery; and
a switch selectively connecting the battery either to the normal charge module or to the solar powered module.

8. The portable electronic device of claim 7, wherein the voltage converting circuit comprises a charge unit converting the voltage output from the solar panel to the charging voltage, the charge unit comprises a transformer, the transformer comprises a primary winding electronically connected to the solar panel, and a secondary winding coupled to the primary winding and electronically connected to the battery.

9. The portable electronic device of claim 8, wherein the charge unit further comprises a first bipolar junction transistor (BJT), a base resistor, a collector resistor, a feedback resistor, and a feedback capacitor, the transformer further comprises a feedback winding coupled with the primary winding and the secondary winding, a base and a collector of the first BJT are connected to a positive pole of the solar panel via the base resistor and the collector resistor respectively, and an emitter of the first BJT is grounded; a dotted terminal of the primary winding is electronically connected to the positive pole of the solar panel, and an undotted terminal of the primary winding is electronically connected to a node between the collector resistor and the collector of the first BJT; the dotted terminal of the feedback winding is electronically connected to a node between the base resistor and the base of the first BJT via the feedback capacitor and the feedback resistor, and an undotted terminal of the feedback winding is grounded; the dotted terminal of the secondary winding is grounded, and an undotted terminal of the secondary winding is electronically connected to the a positive pole of the battery.

10. The portable electronic device of claim 9, wherein the voltage converting circuit further includes a rectifying diode and a filtering capacitor, an anode cathode of the rectifying diode is electronically connected to the undotted terminal of the secondary winding, a cathode of the diode is electronically connected to the positive pole of the battery, the filtering capacitor is electronically connected in parallel with the battery.

11. The portable electronic device of claim 10, wherein the voltage converting circuit further comprises a voltage limiting unit that limits the charging voltage output from the charge unit to a predetermined maximum voltage.

12. The portable electronic device of claim 11, wherein the voltage limiting unit comprises a second BJT, a zener diode, a first voltage dividing resistor, a second voltage dividing resistor, and a current dividing resistor, the first and second voltage dividing resistors are connected in series, and are then connected in parallel with the first filtering capacitor; a cathode of the zener diode is electronically connected to a node between the first and second voltage dividing resistors, and an anode of the zener diode is electronically connected to a base of the second BJT, a collector of the second BJT is electronically connected to a node between the feedback resistor and the base of the first BJT, and an emitter of the second BJT is grounded, the current dividing resistor is electronically connected to the base and the emitter of the second BJT.

13. The portable electronic device of claim 7, wherein the voltage converting circuit further comprises a second filtering capacitor connected to the solar panel in parallel.

14. A portable electronic device, comprising:
a battery;
a normal charge module charging the battery by commercial power;
a solar powered module comprising a plurality of solar panels connected in series and a voltage converting circuit, the solar panels converting light into electricity, and outputting a voltage of the electricity to the voltage converting circuit, the voltage converting circuit converting the voltage output from the solar panel into a charging voltage, and rectifying and filtering the charging voltage that is output to the battery, to charge the battery; and
a switch selectively connecting the battery either to the normal charge module or to the solar powered module.

15. The portable electronic device of claim 14, wherein the voltage converting circuit comprises a charge unit converting the voltage output from the solar panels to the charging voltage, the charge unit comprises a transformer, the transformer comprises a primary winding electronically connected to a positive pole of the solar panels, and a secondary winding coupled to the primary winding and electronically connected to the battery.

16. The portable electronic device of claim 15, wherein the charge unit further comprises a first bipolar junction transistor (BJT), a base resistor, a collector resistor, a feedback resistor, and a feedback capacitor, the transformer further comprises a feedback winding coupled with the primary winding and the secondary winding, a base and a collector of the first BJT are connected to the positive pole of the solar panels via the base resistor and the collector resistor respectively, and an emitter of the first BJT is grounded; a dotted terminal of the primary winding is electronically connected to the positive pole of the solar panels, and an undotted terminal of the primary winding is electronically connected to a node between the collector resistor and the collector of the first BJT; the dotted terminal of the feedback winding is electronically connected to a node between the base resistor and the base of the first BJT via the feedback capacitor and the feedback resistor, and an undotted terminal of the feedback winding is grounded; the dotted terminal of the secondary winding is grounded, and an undotted terminal of the secondary winding is electronically connected to the a positive pole of the battery.

17. The portable electronic device of claim 16, wherein the voltage converting circuit further includes a rectifying diode and a filtering capacitor, an anode cathode of the rectifying diode is electronically connected to the undotted terminal of the secondary winding, a cathode of the diode is electronically connected to the positive pole of the battery, the filtering capacitor is electronically connected in parallel with the battery.

18. The portable electronic device of claim 17, wherein the voltage converting circuit further comprises a voltage limiting unit that limits the charging voltagecoutput from the charge unit to a predetermined maximum voltage.

19. The portable electronic device of claim 18, wherein the voltage limiting unit comprises a second BJT, a zener diode, a first voltage dividing resistor, a second voltage dividing resistor, and a current dividing resistor, the first and second voltage dividing resistors are connected in series, and are then connected in parallel with the first filtering capacitor; a cathode of the zener diode is electronically connected to a node between the first and second voltage dividing resistors, and an anode of the zener diode is electronically connected to a base of the second BJT, a collector of the second BJT is electronically connected to a node between the feedback resistor and the base of the first BJT, and an emitter of the second BJT is grounded, the current dividing resistor is electronically connected to the base and the emitter of the second BJT.

20. The portable electronic device of claim 14, wherein the voltage converting circuit further comprises a second filtering capacitor connected to the solar panels in parallel.
